(19) United States
(12) Patent Application Publication
(10) Pub. No.: US 2009/0146764 A1
(43) Pub. Date: Jun. 11, 2009

(54) Down-converter Having 90-Degree Hybrid Coupler with Open-circuited Transmission line(s) or Short-circuited Transmission line(s) Included Therein

(76) Inventor: Tzong-Jyh Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/125,935

(22) Filed: May 23, 2008

(30) Foreign Application Priority Data
Dec. 10, 2007 (TW) 096147006

(51) Int. Cl. H01P 1/162

(52) U.S. Cl. 333/21 A; 333/117

(57) ABSTRACT

A down-converter includes two low-noise amplifiers, a 90-degree hybrid coupler, and a down-converting circuit. The 90-degree hybrid coupler is coupled to the two low-noise amplifiers for transforming a first amplified signal and a second amplified signal into a first coupler output signal and a second coupler output signal. The 90-degree hybrid coupler includes a coupler main body, a first transmission line, and a second transmission line, wherein the first and the second transmission lines are coupled to the coupler main body. The coupler main body includes two input ports respectively coupled to the two low-noise amplifiers and two output ports for respectively outputting the first and the second coupler output signals. The first and the second transmission lines are each an open-circuited transmission line or a short-circuited transmission line. The down-converting circuit is coupled to the two output ports of the 90-degree hybrid coupler.

### BACKGROUND OF THE INVENTION

1. Field of the Invention

The present invention relates to a down-converter, and more particularly, to a low noise block down-converter (LNB) adding open-circuited transmission lines or short-circuited transmission lines into the 90-degree hybrid coupler to increase a bandwidth of cross polarization isolation (CPI).

2. Description of the Prior Art

Recently, requirements for satellite receiving systems have increased year by year due to satellite communication services having characteristics of wide bandwidth, data broadcasting, and being borderless. However, the resources for satellite bandwidth are finite. Thus, transmission manners such as linear polarization transmission and circular polarization transmission are developed to make better use of the satellite bandwidth. The linear polarization transmission includes vertical linear polarization (VLP) and horizontal linear polarization (HLP), wherein the magnitude of its electric field varies over time but the direction of the electric field remains the same. The circular polarization transmission includes right-hand circular polarization (RHCP) and left-hand circular polarization (LHCP), wherein the magnitude of its electric field does not vary over time, but the direction of the electric field does. Generally speaking, antennas with a same polarization type are used for receiving satellite signals with the same polarization type, but antennas with different polarization types may be used for receiving satellite signals with different polarization types due to certain antenna designs. For example, a linear polarization antenna can be used for receiving circular polarization waveforms. In such conditions, because the linear polarization antenna only catches linear polarization component signals (i.e., VLP component signals and HLP component signals) corresponding to the RHCP signal and the LHCP signal, the VLP component signals and HLP component signals received by the linear polarization antenna need to be combined to form the RHCP signal and the LHCP signal through a 90-degree hybrid coupler.

Please refer to FIG. 1. FIG. 1 is a diagram showing an architecture of a 90-degree hybrid coupler 100 according to the prior art. The 90-degree hybrid coupler 100 includes a coupler body 180, wherein the coupler body 180 includes a first input port 110, a second input port 120, a first output port 130, and a second output port 140. Consider a condition where the four ports match to each other. At this time, if an input signal Sᵢₙ is inputted to the first input port 110, signals outputted by the first output port 130 and the second output port 140 have the same amplitude and a phase difference of 90 degrees and there is no signal coupled to the second input port 120. In such a conventional architecture, the isolation between the first input port 110 and the second input port 120 and the isolation between the first output port 130 and the second output port 140 significantly affect the cross polarization isolation (CPI) of the 90-degree hybrid coupler 100. If the isolation of the four ports is not sufficient, the first input port 110 couples signals to the second input port 120 through a path 150, which results in cross polarization interference. The first output port 130 couples signals to the second output port 140 through another path 160, which results in other cross polarization interference.

Please refer to FIG. 2. FIG. 2 is a diagram showing the isolation of the 90-degree hybrid coupler 100 in FIG. 1. The horizontal axis represents frequency (Hz) that distributes from 10 GHz to 14 GHz, and the vertical axis represents isolation (dB). Assuming that the isolation equaling −18 dB is used as a threshold value, a bandwidth BW1 of the isolation of the 90-degree hybrid coupler 100 is substantially 1400 MHz.

Because the conventional 90-degree hybrid coupler 100 has the advantages of easy design and simple manufacturing, it is frequently applied to low noise block down-converters (LNB). However, it has the disadvantage of being unable to provide isolation across a wide bandwidth, which results in cross polarization interference at the input ports and output ports. Therefore, the receiving effectiveness of the LNB is greatly reduced.

### SUMMARY OF THE INVENTION

It is one of the objectives of the present invention to provide a down-converter with a high bandwidth of cross polarization isolation (CPI) to solve the abovementioned problems.

The present invention provides a down-converter. The down-converter includes two low-noise amplifiers, a 90-degree hybrid coupler, and a down-converting circuit. The two low-noise amplifiers are respectively used for amplifying a first beacon signal and a second beacon signal to generate a first amplified signal and a second amplified signal. The 90-degree hybrid coupler is used for transforming the first amplified signal and the second amplified signal into a first coupler output signal and a second coupler output signal. The 90-degree hybrid coupler includes a coupler main body, a first transmission line, and a second transmission line. The coupler main body includes two input ports and two output ports. The two input ports are respectively coupled to the two low-noise amplifiers for receiving the first amplified signal and the second amplified signal. The two output ports are respectively used for outputting the first coupler output signal and the second coupler output signal. The first transmission line is coupled to the coupler main body. The second transmission line is coupled to the coupler main body, wherein the first transmission line and the second transmission line are each an open-circuited transmission line or a short-circuited transmission line. The down-converting circuit has two input ends respectively coupled to the two output ports of the 90-degree hybrid coupler for down-converting the first coupler output signal and the second coupler output signal.

In one embodiment, the first transmission line is coupled to one of the two input ports of the 90-degree hybrid coupler, and the second transmission line is coupled to another one of the two input ports of the 90-degree hybrid coupler.

In one embodiment, the first transmission line is coupled to one of the two output ports of the 90-degree hybrid coupler, and the second transmission line is coupled to another one of the two output ports of the 90-degree hybrid coupler.

In one embodiment, the 90-degree hybrid coupler further includes a third transmission line coupled to one of the two output ports of the 90-degree hybrid coupler and a fourth transmission line coupled to another one of the two output ports of the 90-degree hybrid coupler, wherein the third transmission line and the fourth transmission line are each an open-circuited transmission line or a short-circuited transmission line. The first transmission line is coupled to one of the two input ports of the 90-degree hybrid coupler, and the second transmission line is coupled to another one of the two input ports of the 90-degree hybrid coupler.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an architecture of a 90-degree hybrid coupler according to the prior art.

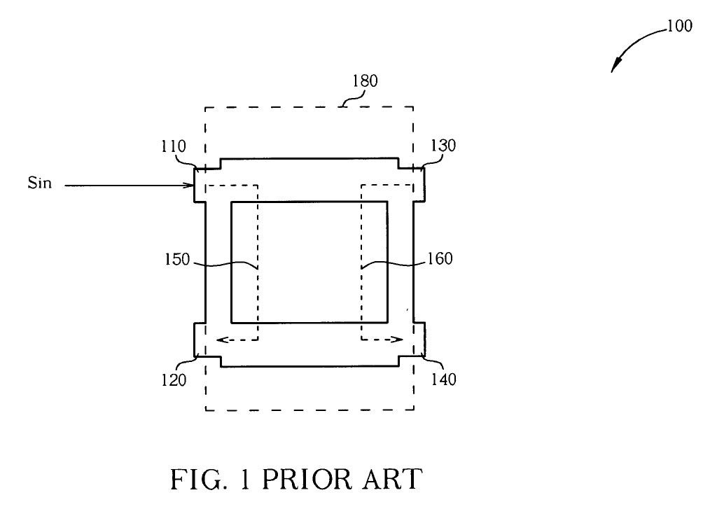

FIG. 2 is a diagram showing the isolation of the 90-degree hybrid coupler in FIG. 1.

FIG. 3 is a block diagram of a down-converter according to an embodiment of the present invention.

FIG. 4 is a diagram showing an open-circuited transmission line and a short-circuited transmission line according to an embodiment of the present invention.

FIG. 5 is a diagram showing an architecture of a 90-degree hybrid coupler according to an embodiment of the present invention.

FIG. 6 is a diagram showing varied embodiments of the open-circuited transmission line shown in FIG. 4.

FIG. 7 is a diagram showing varied embodiments of the short-circuited transmission line shown in FIG. 4.

FIG. 8 is a diagram showing the isolation of the 90-degree hybrid coupler in FIG. 5.

### DETAILED DESCRIPTION

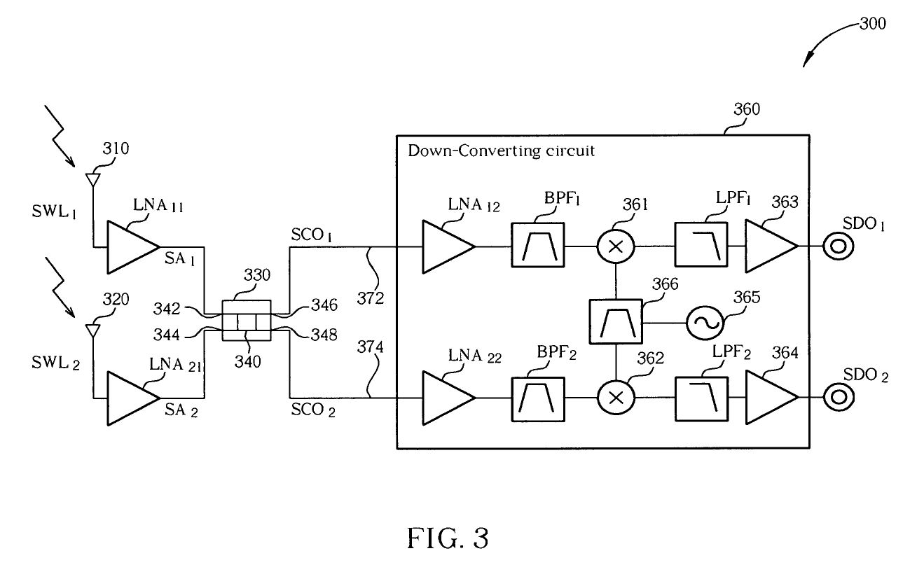

Please refer to FIG. 3. FIG. 3 is a block diagram of a down-converter 300 according to an embodiment of the present invention. In this embodiment, the down-converter 300 can be a LNB, but this is not a limitation of the present invention and it can be a down-converter of a different type. The down-converter 300 includes two antennas 310 and 320, two low-noise amplifiers LNA₁₁ and LNA₂₁, a 90-degree hybrid coupler 330, and a down-converting circuit 360. The antenna 310 and the antenna 320 are respectively used for receiving a first beacon signal SWL₁ and a second beacon signal SWL₂. The low-noise amplifiers LNA₁₁ and LNA₂₁ are respectively coupled to the antenna 310 and the antenna 320 and are respectively used for amplifying the first beacon signal SWL₁ and the second beacon signal SWL₂ to generate a first amplified signal SA₁ and a second amplified signal SA₂. The 90-degree hybrid coupler 330 transforms the first amplified signal SA₁ and the second amplified signal SA₂ into a first coupler output signal SCO₁ and a second coupler output signal SCO₂. The 90-degree hybrid coupler 330 includes a coupler body 340, wherein the coupler body 340 includes a first input port 342, a second input port 344, a first output port 346, and a second output port 348. The first input port 342 and the second input port 344 are respectively coupled to the two low-noise amplifiers LNA₁₁ and LNA₂₁ for receiving the first amplified signal SA₁ and the second amplified signal SA₂. The first output port 346 and the second output port 348 are respectively used for outputting the first coupler output signal SCO₁ and the second coupler output signal SCO₂. The 90-degree hybrid coupler 330 further includes a first transmission line, a second transmission line, a third transmission line, and a fourth transmission line, wherein the transmission lines are each an open-circuited transmission line or a short-circuited transmission line. Note that each of the transmission lines are not shown in FIG. 3 but will be detailed in the following figures and embodiments. The down-converting circuit 360 includes two input ends 372 and 374 respectively coupled to the first output port 346 and the second output port 348 of the 90-degree hybrid coupler 330 for down-converting the first coupler output signal SCO₁ and the second coupler output signal SCO₂ to generate a first down-converted output signal SDO₁ and a second down-converted output signal SDO₂.

Please keep referring to FIG. 3. In this embodiment, the down-converting circuit 360 includes two low-noise amplifiers LNA₁₂ and LNA₂₂, two first band-pass filters BPF₁ and BPF₂, two mixers 361 and 362, two low-pass filters LPF₁ and LPF₂, two amplifiers 363 and 364, a local oscillator 365, and a second band-pass filter 366, wherein a connection manner of each elements is shown in FIG. 3. Please note that the operations of each element of the down-converting circuit 360 are not the emphases of the present invention, and further description for the down-converting circuit 360 is omitted here for brevity. In addition, the abovementioned down-converting circuit 360 is merely an embodiment of the present invention, and those skilled in the art should appreciate that it should not be considered to be a limitation of the scope of the present invention. For example, the stages of the low-noise amplifiers LNA₁₂ and LNA₂₂ can be increased or removed depending on design structures.

Please note that the 90-degree hybrid coupler 330 mentioned above is merely an implementation, but is not limited to this only and can be 90-degree hybrid coupler of another type. The first beacon signal SWL₁ and the second beacon signal SWL₂ are both satellite signals. For example, in one embodiment, the down-converter 300 is used for receiving a LHCP signal and a RHCP signal. The antenna 310 (such as a horizontal linear polarization antenna) is used for receiving a HLP component signal corresponding to the LHCP signal and a HLP component signal corresponding to the RHCP signal. The antenna 320 (such as a vertical linear polarization antenna) is used for receiving a VLP component signal corresponding to the LHCP signal and a VLP component signal corresponding to the RHCP signal. After the combination of the 90-degree hybrid coupler 330, the HLP component signal corresponding to the LHCP signal and the VLP component signal corresponding to the LHCP signal are combined into the LHCP signal to generate the first coupler output signal SCO₁, and the HLP component signal corresponding to the RHCP signal and the VLP component signal corresponding to the RHCP signal are combined into the RHCP signal to generate the second coupler output signal SCO₂. In other words, the first beacon signal SWL₁ includes the HLP component signal corresponding to the LHCP signal and the HLP component signal corresponding to the RHCP signal, the second beacon signal SWL₂ includes the VLP component signal corresponding to the LHCP signal and the VLP component signal corresponding to the RHCP signal, the first coupler output signal SCO₁ includes the LHCP signal, and the second coupler output signal SCO₂ includes the RHCP signal. In another embodiment, the down-converter 300 is used for receiving a HLP signal and a VLP signal. The antenna 310 (such as a left-hand circular polarization antenna) is used for receiving a LHCP component signal corresponding to the HLP signal and a LHCP component signal corresponding to the VLP signal. The antenna 320 (such as a right-hand circular polarization antenna) is used for receiving a RHCP component signal corresponding to the HLP signal and a RHCP component signal corresponding to the VLP signal. After the combination of the 90-degree hybrid coupler 330, the LHCP component signal corresponding to the HLP signal and the RHCP component signal corresponding to the HLP signal are combined into the HLP signal to generate the first coupler output signal SCO₁, and the LHCP component signal corresponding to the VLP signal and the RHCP component signal corresponding to the VLP signal are combined into the VLP signal to generate the second coupler output signal SCO₂. In other words, the first beacon signal SWL₁ includes the LHCP component signal corresponding to the HLP signal and the LHCP component signal corresponding to the VLP signal, the second beacon signal SWL₂ includes the RHCP component signal corresponding to the HLP signal and the RHCP component signal corresponding to the VLP signal, the first coupler output signal SCO₁ includes the HLP signal, and the second coupler output signal SCO₂ includes the VLP signal.

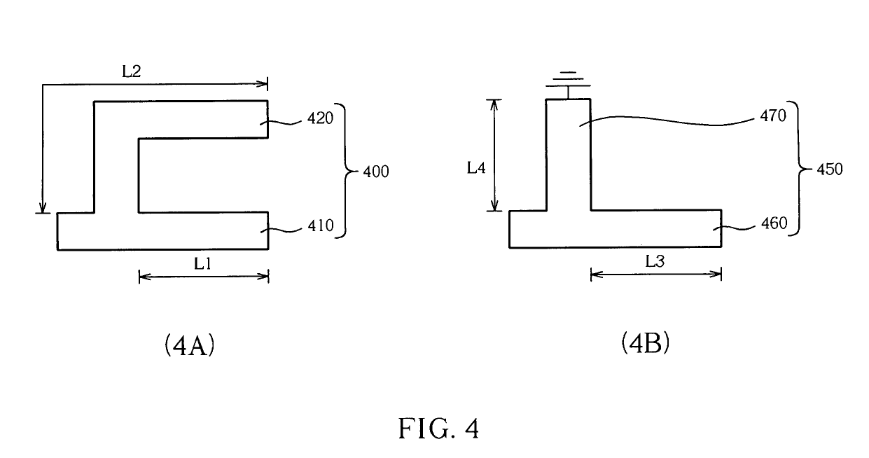

Please refer to FIG. 4. FIG. 4 is a diagram showing an open-circuited transmission line and a short-circuited transmission line according to an embodiment of the present invention, wherein 4A shows an embodiment of an open-circuited transmission line 400 and 4B shows an embodiment of a short-circuited transmission line 450. As shown in 4A, the open-circuited transmission line 400 includes a first section 410 and a second section 420 coupled to the first section 410. The length L1 of the first section 410 is approximately one-fourth of the wavelength of the beacon signal (i.e., the first beacon signal SWL₁ or the second beacon signal SWL₂) received by the down-converter 300, and the length L2 of the second section 420 is approximately one half of the wavelength of the beacon signal received by the down-converter 300. As shown in 4B, the short-circuited transmission line 450 includes a first section 460 and a second section 470 coupled to the first section 460. The length L3 of the first section 460 is approximately one-fourth of a wavelength of the beacon signal received by the down-converter 300, and the length L4 of the second section 470 is approximately one-fourth of a wavelength of the beacon signal received by the down-converter 300. The second section 470 is further coupled to a grounding end.

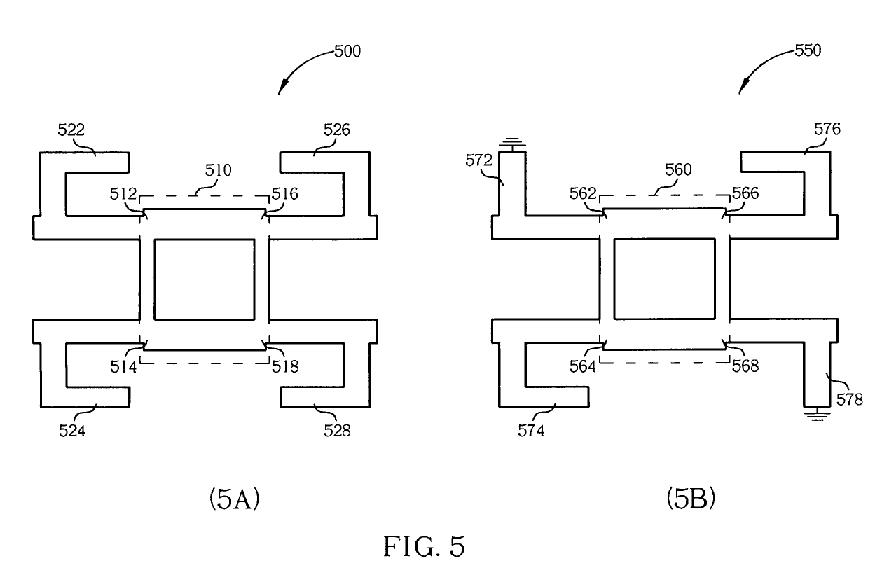

Please refer to FIG. 5. FIG. 5 is a diagram showing an architecture of a 90-degree hybrid coupler according to an embodiment of the present invention. As shown in 5A, the 90-degree hybrid coupler 500 includes a coupler body 510, a first transmission line 522, a second transmission line 524, a third transmission line 526, and a fourth transmission line 528. The first transmission line 522, the second transmission line 524, the third transmission line 526, and the fourth transmission line 528 are respectively coupled to a first input port 512, a second input port 514, a first output port 516, and a second output port 518 of the coupler body 510. In 5A, the transmission lines 522, 524, 526, and 528 are all implemented by the open-circuited transmission line 400 shown in FIG. 4. As shown in 5B, a 90-degree hybrid coupler 550 includes a coupler body 560, a first transmission line 572, a second transmission line 574, a third transmission line 576, and a fourth transmission line 578. The first transmission line 572, the second transmission line 574, the third transmission line 576, and the fourth transmission line 578 are respectively coupled to a first input port 562, a second input port 564, a first output port 566, and a second output port 568 of the coupler body 560. In 5B, the first transmission line 572, and the fourth transmission line 578 are implemented by the short-circuited transmission line 450 shown in FIG. 4, and the second transmission line 574 and the third transmission line 576 are implemented by the open-circuited transmission line 400 shown in FIG. 4.

The abovementioned embodiments are presented merely for illustrating practicable designs of the 90-degree hybrid coupler of the present invention, and should not be considered limitations of the present invention. Each of the four transmission lines can be implemented by the open-circuited transmission line 400 or the short-circuited transmission line 450. If the transmission lines need to be added to all of the four ports, there are 16 variations (24=16) in total. Please also note that if only the first transmission line 522 and the second transmission line 524 are added to the first input port 562 and the second input port 564, the bandwidth of the isolation of the 90-degree hybrid coupler can be improved as well. Similarly, if only the third transmission line 576 and the fourth transmission line 578 are added to the first output port 566 and the second output port 568, the bandwidth of the isolation of the 90-degree hybrid coupler can be improved as well, which should also belong to the scope of the present invention. Those skilled in the art should appreciate that various modifications of the architecture of the 90-degree hybrid coupler may be made without departing from the spirit of the present invention.

Please also note that, the open-circuited transmission line 400 and the short-circuited transmission line 450 shown in FIG. 4 are merely an embodiment of the present invention, and, as is well known by persons of ordinary skill in the art, suitable variations can be applied to the transmission lines. In the following, several embodiments illustrate various modifications of the open-circuited transmission line 400 and the short-circuited transmission line 450.

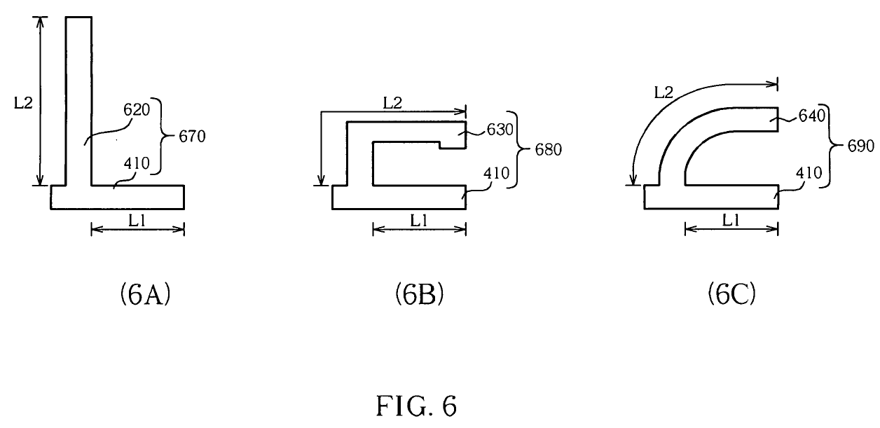

Please refer to FIG. 6. FIG. 6 is a diagram showing varied embodiments of the open-circuited transmission line 400 shown in FIG. 4. In 6A, the architecture of the open-circuited transmission line 670 is similar to the open-circuited transmission line 400 in FIG. 4, and the difference between them is that a second section 620 of the open-circuited transmission line 670 does not include any bends. In 6B, the difference between the open-circuited transmission line 680 and the open-circuited transmission line 400 shown in FIG. 4 is that a second section 630 of the open-circuited transmission line 680 includes more than one bend. In 6C, the difference between the open-circuited transmission line 690 and the open-circuited transmission line 400 shown in FIG. 4 is that a second section 640 of the open-circuited transmission line 690 is not a straight line (the second section 640 is an arced line in this embodiment).

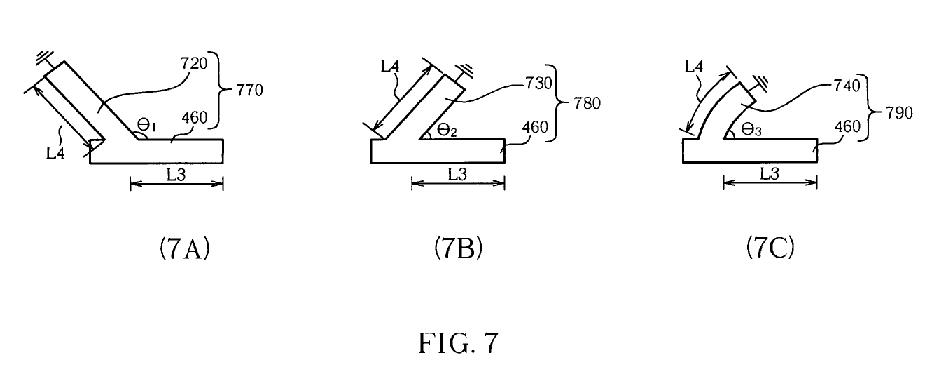

Please refer to FIG. 7. FIG. 7 is a diagram showing varied embodiments of the short-circuited transmission line 450 shown in FIG. 4. In 7A, the architecture of the short-circuited transmission line 770 is similar to the short-circuited transmission line 450 in FIG. 4, and the difference between them is that a joint point of the first section 460 and a second section 720 included by the short-circuited transmission line 770 forms an oblique angle; that is, the angle θ₁ is not 90° (in this embodiment, θ₁>90°). In 7B, the difference between a short-circuited transmission line 780 and the short-circuited transmission line 450 shown in FIG. 4 is that the joint point of the first section 460 and a second section 730 included by the short-circuited transmission line 780 forms an oblique angle; that is, the angle θ₂ is not 90° (in this embodiment, θ₂<90°). In 7C, the difference between a short-circuited transmission line 790 and the short-circuited transmission line 450 shown in FIG. 4 is that the joint point of the first section 460 and a second section 740 included by the short-circuited transmission line 790 forms an arc. In other words, the angle θ₃ is an arc angle, and the second section 740 is not a straight line (the second section 740 is an arc line in this embodiment).

Those skilled in the art should appreciate that various modifications of the open-circuited transmission line and the short-circuited transmission line may be made without departing from the spirit of the present invention. The abovementioned embodiments are presented merely for illustrating practicable designs of the present invention, and should not be considered to be limitations of the present invention. Furthermore, the number of bends, the shape, and the included angle of the first section and the section include by the open-circuited transmission line or the short-circuited transmission line are not limited and can be adjusted depending on design requirements.

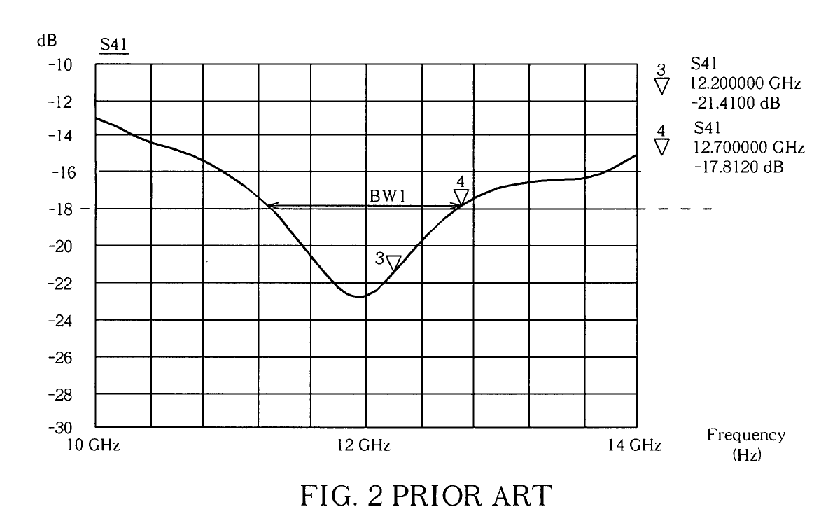

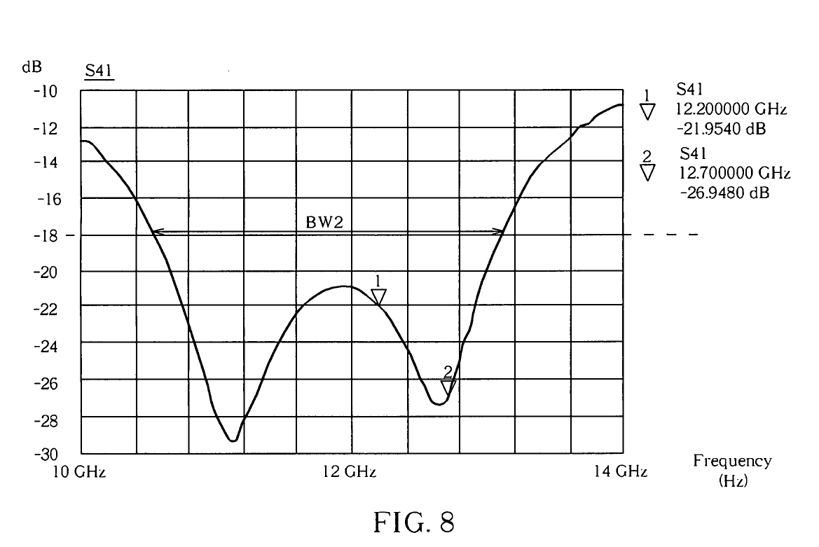

Please refer to FIG. 8. FIG. 8 is a diagram showing the isolation of the 90-degree hybrid coupler 500 in FIG. 5. The horizontal axis represents the frequency (Hz), distributed from 10 GHz to 14 GHz, and the vertical axis represents isolation (dB). Assuming that the isolation equaling −18 dB is used as a threshold value, a bandwidth BW2 of the isolation of the 90-degree hybrid coupler 500 is substantially 2600 MHz. As is known by comparing the bandwidth BW2 with the bandwidth BW1 (i.e., 1400MHz) of the isolation of the 90-degree hybrid coupler 100 shown in FIG. 2, the bandwidth of the isolation of the 90-degree hybrid coupler disclosed in the present invention can be greatly improved. Therefore, the 90-degree hybrid coupler disclosed in the present invention can obtain a CPI with a wider bandwidth, which gives the LNB better receiving efficiency.

From the above descriptions, the present invention provides a down-converter with a higher bandwidth of CPI. Through additionally disposing open-circuited transmission lines or short-circuited transmission lines to the two input ports, the two output ports, or all ports of the 90-degree hybrid coupler, the bandwidth of the isolation of the 90-degree hybrid coupler is greatly improved. Therefore, linear polarization antennas can be used for receiving the RHCP signal and the LHCP signal if the 90-degree hybrid coupler disclosed in the present invention is adopted. In addition, because the bandwidth of the isolation of the 90-degree hybrid coupler is improved, cross polarization interference can be avoided, which improve the receiving efficiency of the LNB. Furthermore, the architectures of the open-circuited transmission line and the short-circuited transmission line are very simple and can be manufactured cheaply, which will not increase difficulties in design and extra costs.

Those skilled in the art will readily observe that numerous modifications and alterations of the device and method may be made while retaining the teachings of the invention.

What is claimed is:

1. A down-converter, comprising:
two low-noise amplifiers, for respectively amplifying a first beacon signal and a second beacon signal to generate a first amplified signal and a second amplified signal;
a 90-degree hybrid coupler, for transforming the first amplified signal and the second amplified signal into a first coupler output signal and a second coupler output signal, the 90-degree hybrid coupler comprising:
a coupler main body, comprising:
two input ports, respectively coupled to the two low-noise amplifiers, for receiving the first amplified signal and the second amplified signal; and
two output ports, for respectively outputting the first coupler output signal and the second coupler output signal;
a first transmission line, coupled to the coupler main body; and
a second transmission line, coupled to the coupler main body, wherein the first transmission line and the second transmission line are each an open-circuited transmission line or a short-circuited transmission line; and
a down-converting circuit, having two input ends respectively coupled to the two output ports of the 90-degree hybrid coupler, for down-converting the first coupler output signal and the second coupler output signal.

2. The down-converter of claim 1, wherein:
the first transmission line is coupled to one of the two input ports of the 90-degree hybrid coupler; and
the second transmission line is coupled to another one of the two input ports of the 90-degree hybrid coupler.

3. The down-converter of claim 1, wherein:
the first transmission line is coupled to one of the two output ports of the 90-degree hybrid coupler; and
the second transmission line is coupled to another one of the two output ports of the 90-degree hybrid coupler.

4. The down-converter of claim 1, wherein the 90-degree hybrid coupler further comprises:
a third transmission line, coupled to one of the two output ports of the 90-degree hybrid coupler; and
a fourth transmission line, coupled to another one of the two output ports of the 90-degree hybrid coupler, wherein the third transmission line and the fourth transmission line are each an open-circuited transmission line or a short-circuited transmission line;
wherein the first transmission line is coupled to one of the two input ports of the 90-degree hybrid coupler, and the second transmission line is coupled to another one of the two input ports of the 90-degree hybrid coupler.

5. The down-converter of claim 1, wherein:
at least one of the first transmission line and the second transmission line is an open-circuited transmission line, and the open-circuited transmission line comprises a first section and a second section coupled to the first section; and
a length of the first section is approximately one-fourth of a wavelength of a beacon signal received by the down-converter, and a length of the second section is approximately one half of a wavelength of the beacon signal received by the down-converter.

6. The down-converter of claim 1, wherein:
at least one of the first transmission line and the second transmission line is a short-circuited transmission line, and the short-circuited transmission line comprises a first section and a second section coupled to the first section; and
a length of the first section is approximately one-fourth of a wavelength of a beacon signal received by the down-converter, and a length of the second section is approximately one-fourth of a wavelength of the beacon signal received by the down-converter.

7. The down-converter of claim 1, wherein the down-converter is used for receiving a left-hand circular polarization (LHCP) signal and a right-hand circular polarization (RHCP) signal; the first beacon signal comprises a horizontal linear polarization (HLP) component signal corresponding to the LHCP signal and a HLP component signal corresponding to the RHCP signal, and the second beacon signal comprises a vertical linear polarization (VLP) component signal corresponding to the LHCP signal and a VLP component signal corresponding to the RHCP signal; and the first coupler output signal comprises the LHCP signal and the second coupler output signal comprises the RHCP signal.

8. The down-converter of claim 1, wherein the down-converter is used for receiving a HLP signal and a VLP signal; the first beacon signal comprises a LHCP component signal corresponding to the HLP signal and a LHCP component signal corresponding to the VLP signal, and the second beacon signal comprises a RHCP component signal corresponding to the HLP signal and a RHCP component signal corresponding to the VLP signal; and the first coupler output signal comprises the HLP signal and the second coupler output signal comprises the VLP signal.

9. The down-converter of claim 1, wherein the down-converter is a low noise block down-converter (LNB), and the first beacon signal and the second beacon signal are both satellite signals.

10. A down-converter, comprising:
a 90-degree hybrid coupler, comprising:
a coupler main body, having a first input port for receiving a HLP component signal corresponding to a LHCP signal and a HLP component signal corresponding to RHCP signal, a second input port for receiving a VLP component signal corresponding to the LHCP signal and a VLP component signal corresponding to the RHCP signal, a first output port for outputting the LHCP signal, and a second output port for outputting the RHCP signal; and
two transmission lines, respectively coupled to the first input port and the second input port, or respectively coupled to the first output port and the second output port, wherein the two transmission lines are each an open-circuited transmission line or a short-circuited transmission line; and
a down-converting circuit, for down-converting the LHCP signal and the RHCP signal.

11. The down-converter of claim 10, wherein the open-circuited transmission line comprises a first section and a second section coupled to the first section; and a length of the first section is approximately one-fourth of a wavelength of a beacon signal received by the down-converter, and a length of the second section is approximately one half of a wavelength of the beacon signal received by the down-converter.

12. The down-converter of claim 10, wherein the short-circuited transmission line comprises a first section and a second section coupled to the first section; and a length of the first section is approximately one-fourth of a wavelength of a beacon signal received by the down-converter, and a length of the second section is approximately one-fourth of a wavelength of the beacon signal received by the down-converter.

13. A down-converter, comprising:
a 90-degree hybrid coupler, comprising:
a coupler main body, having a first input port for receiving a LHCP component signal corresponding to a VLP signal and a LHCP component signal corresponding to HLP signal, a second input port for receiving a RHCP component signal corresponding to the VLP signal and a RHCP component signal corresponding to the HLP signal, a first output port for outputting the VLP signal, and a second output port for outputting the HLP signal; and
two transmission lines, respectively coupled to the first input port and the second input port, or respectively coupled to the first output port and the second output port, wherein the two transmission lines are each an open-circuited transmission line or a short-circuited transmission line; and
a down-converting circuit, for down-converting the VLP signal and the HLP signal.

14. The down-converter of claim 13, wherein the open-circuited transmission line comprises a first section and a second section coupled to the first section; and a length of the first section is approximately one-fourth of a wavelength of a beacon signal received by the down-converter, and a length of the second section is approximately one half of a wavelength of the beacon signal received by the down-converter.

15. The down-converter of claim 13, wherein the short-circuited transmission line comprises a first section and a second section coupled to the first section; and a length of the first section is approximately one-fourth of a wavelength of a beacon signal received by the down-converter, and a length of the second section is approximately one-fourth of a wavelength of the beacon signal received by the down-converter.
